(19) United States
(12) Patent Application Publication
(10) Pub. No.: US 2024/0259277 A1
(43) Pub. Date: Aug. 1, 2024

(54) EDGE COMPUTING NETWORK DEPLOYMENT FOR FIFTH-GENERATION (5G) SYSTEMS

(71) Applicant: Intel Corporation, Santa Clara, CA (US)

(72) Inventors: Joey CHOU, Santa Clara, CA (US); Yizhi YAO, Chandler, AZ (US)

(21) Appl. No.: 18/559,999

(22) PCT Filed: Dec. 22, 2022
(86) PCT No.: PCT/US2022/053829

§ 371 Date: Nov. 9, 2023

Related U.S. Application Data
(60) Provisional application No. 63/295,446, filed on Dec. 30, 2021.

(51) Int. Cl. H04L 41/40; H04L 41/0895; H04L 67/52; H04W 84/04

(52) U.S. Cl. CPC H04L 41/40; H04L 41/0895; H04L 67/52; H04W 84/042

(57) ABSTRACT

Various embodiments herein may relate to edge computing network deployments, and in particular, some embodiments may be directed to instantiating edge application server (EAS) virtual network functions (VNFs). An edge computing service provider (ECSP) management system is to: receive a request for instantiation of a virtual network function (VNF) that includes deployment requirements comprising software image information associated with the instantiation of the VNF; and instantiate the VNF based on the deployment requirements.

### CROSS REFERENCE TO RELATED APPLICATION

The present application claims priority to U.S. Provisional Patent Application No. 63/295,446, which was filed Dec. 30, 2021.

### FIELD

Various embodiments generally may relate to the field of wireless communications. For example, some embodiments may relate to edge computing network deployments in fifth-generation (5G) systems. In particular, some embodiments may be directed to instantiating edge application server (EAS) virtual network functions (VNFs).

### BACKGROUND

Edge computing networks in 5G systems may include a number of components that interact to deploy VNFs. For example some edge computing networks may include an application service provider (ASP) that requests an edge computing service provider (ECSP) management system to deploy an EAS virtual network function VNF. Among other things, embodiments of the present disclosure are directed to information models for deployment requirements, including service area requirements, quality of service (QoS) requirements, and software image information, which are needed for EAS, EES, and ECS deployment.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example of an edge computing network deployment in accordance with various embodiments.

FIG. 2 illustrates an example of edge computing networks in accordance with various embodiments.

FIG. 3 schematically illustrates a wireless network in accordance with various embodiments.

FIG. 4 schematically illustrates components of a wireless network in accordance with various embodiments.

FIG. 5 is a block diagram illustrating components, according to some example embodiments, able to read instructions from a machine-readable or computer-readable medium (e.g., a non-transitory machine-readable storage medium) and perform any one or more of the methodologies discussed herein.

FIGS. 6, 7, and 8 illustrate examples of procedures for practicing the various embodiments discussed herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

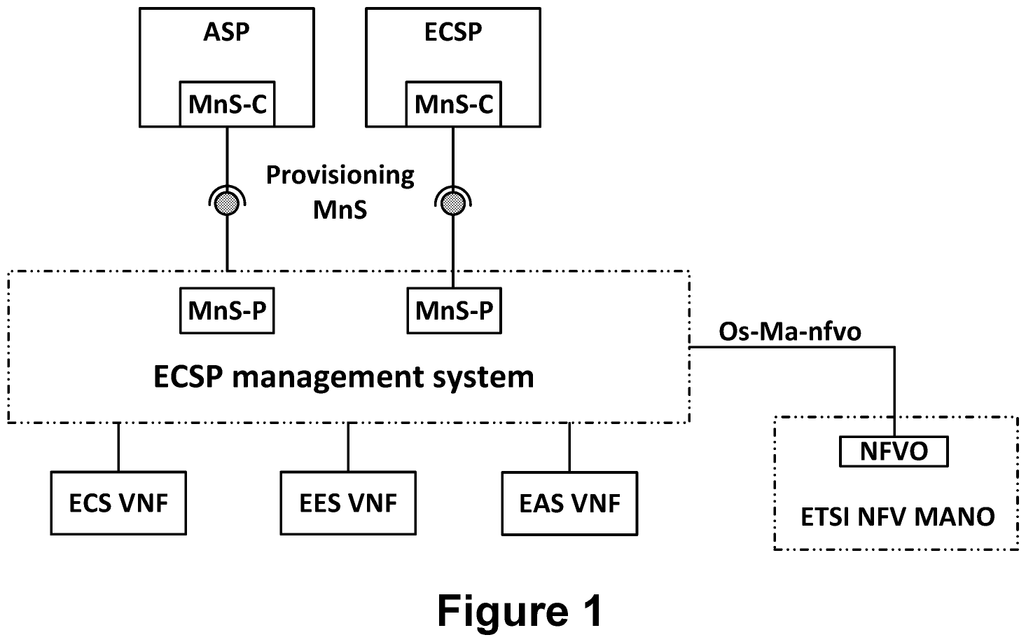

FIG. 1 shows an example framework for an edge computing network deployment in accordance with various embodiments. In this example, the application service provider (ASP), as a consumer, may consume the provisioning Management Service (MnS) to request the edge computing service provider (ECSP) management system to deploy the edge application server (EAS) virtual network function (VNF). The ECSP consumer may consume the provisioning Management Service (MnS) to request the ECSP management system to deploy the edge enabling server (EES) and edge configuration server (ECS) VNFs.

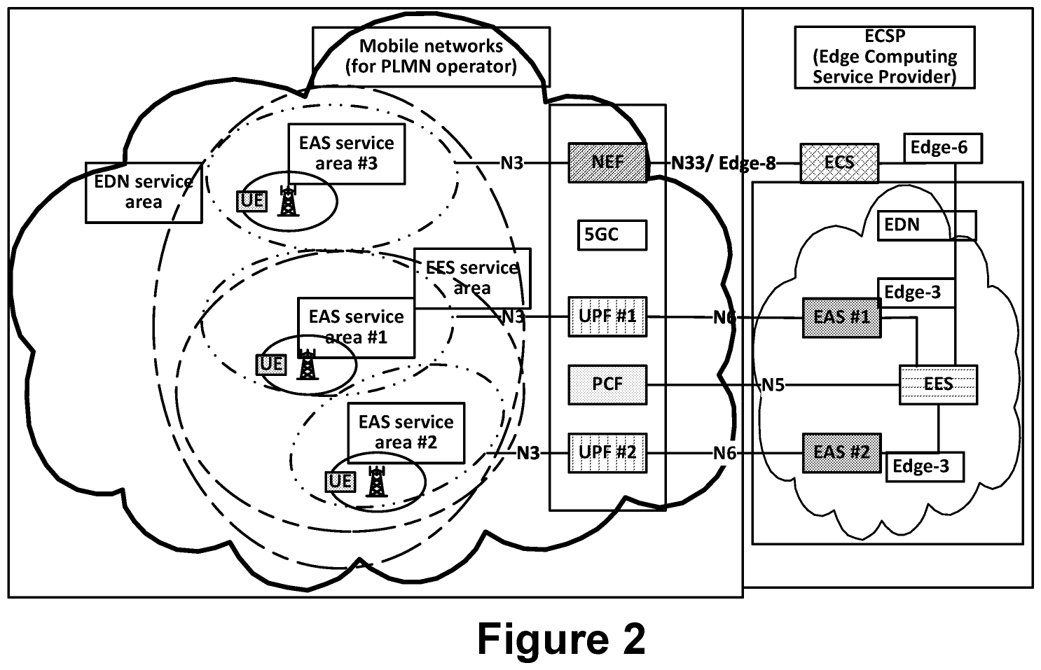

FIG. 2 depicts an example of edge computing networks, where the mobile networks are connected to an edge data network (EDN) that includes two EASs and one EES. The EAS(s) are connected to the user plane function (UPF) via the N6 interface to carry the applications data traffic, while EAS(s) and EES are connected to the policy control function (PCF) via the N5 interfaces. The EES may act as a trusted AF (which may refer to an “access function”) in the fifth generation core (5GC), on which information can be sent to the session management function (SMF) via PCF to influence traffic routing via PCF. The ECS is connected to network exposure function (NEF) in the mobile networks via N33/Edge-8 interface and EES via Edge-6 interfaces. Some embodiments may utilize the definitions in 3GPP TS 23.558, v. 17.1.0, 2021 Sep. 24, which defines the EAS service areas, EES service areas, and EDN service area that are used to determine where in the mobile networks will be serve by EAS, EES, and ECS, respectively.

Some embodiments herein relate to defining the information models for deployment requirements, including service area requirements, quality of service (QoS) requirements, and software image information, which are needed for EAS, EES, and ECS deployment. Some embodiments may be related to 3GPP TS 28.538, v. 0.4.0, 2021 Dec. 8. More specifically, some embodiments may relate to Mobility Robustness Optimization (MRO).

In some embodiments, referring again to FIG. 1, an ASP may consume the provisioning MnS with createMOI operation for EASRequirements IOC to request ECSP provisioning MnS producer to start the EAS VNF instantiation, where the EASRequirements IOC, defined below, contains the deployment requirements.

### 6.3.2 EASRequirements

### Definition 6.3.2.1

This represents the requirements needed to deploy EAS(s).

### 6.3.2.2 Attributes

| | Support | | | | |
|---|---|---|---|---|---|
| Attribute name | Qualifier | isReadable | isWritable | isInvariant | isNotifyable |
| requiredEASserving | M | T | F | F | T |
| Location | | | | | |
| softwareImageInfo | M | T | F | F | T |
| qoSRequirements | M | T | F | F | T |

6.3.y SoftwareImageInfo <<dataType>>

### 6.3.y.1 Definition

This datatype represents the software image information.

### 6.3.y.2 Attributes

| | Support | | | | |
|---|---|---|---|---|---|
| | Qualifier | isReadable | isWritable | isInvariant | isNotifyable |
| Attribute name | | | | | |
| minimumDisk | M | T | T | F | T |
| minimumRAM | M | T | T | F | T |
| Attribute related | | | | | |
| to role | | | | | |
| swImageRef | M | T | T | F | T |

6.3.z QoSRequirements <<dataType>>

### 6.3.z.1 Definition

This datatype represents the QoS requirements (see clause 3.4.2 in GSMA OPG.02) for the EAS deployment.

### 6.3.z.2 Attributes

| | Support | | | | |
|---|---|---|---|---|---|
| Attribute name | Qualifier | isReadable | isWritable | isInvariant | isNotifyable |
| ueToEasBW | M | T | T | F | T |
| ueToEasLatency | M | T | T | F | T |

The following lists the definition of attributes associated with EASRequirements IOC.

| | | |
|---|---|---|
| softwareImageInfo | This refers to thesoftware image | type: |
| | information (e.g., software image location, | SoftwareImageInfo |
| | minimum RAM, disk requirements) (see | multiplicity: 1 |
| | clause 7.1.6.5 in in ETSI NFV IFA-011). It | isOrdered: N/A |
| | is defined as a datatype (see clause 6.3.y). | isUnique: True |
| | allowedValues: N/A | defaultValue: None |
| | | isNullable: False |
| swImageRef | It indicates the reference to the actual | type: String |
| | software image that is represented by URL | multiplicity: 1 |
| | (see clause 7.1.6.5 in in ETSI NFV IFA- | isOrdered: N/A |
| | 011). | isUnique: True |
| | | defaultValue: None |
| | | isNullable: False |
| minimumDisk | It indicates the minimum disk size | type: Integer |
| | requirement for the EAS software (see | multiplicity: 1 |
| | clause 7.1.6.5 in in ETSI NFV IFA-011). | isOrdered: N/A |
| | The unit is Megabyte. | isUnique: True |
| | | defaultValue: None |
| | | isNullable: False |
| minimumRAM | It indicates the minimum RAM size | type: Integer |
| | requirement for the EAS software (see | multiplicity: 1 |
| | clause 7.1.6.5 in in ETSI NFV IFA-011). | isOrdered: N/A |
| | The unit is Megabyte. | isUnique: True |
| | | defaultValue: None |
| | | isNullable: False |
| qoSRequirements | This refers to thesoftware image | type: |
| | information (e.g., software image location, | QoSRequirements |
| | minimum RAM, disk requirements) (see | multiplicity: 1 |
| | clause 7.1.6.5 in in ETSI NFV IFA-011). It | isOrdered: N/A |
| | is defined as a datatype (see clause 6.3.z). | isUnique: True |
| | allowedValues: N/A | defaultValue: None |
| | | isNullable: False |
| ueToEasBW | It indicates the bidirectional data rate | type: Integer |
| | between UE and EAS (see clause 3.4.2 in | multiplicity: 1 |
| | GSMA OPG.02). | isOrdered: N/A |
| | The unit is Megabyte. | isUnique: True |
| | | defaultValue: None |
| | | isNullable: False |
| ueToEasLatency | It indicates the round-trip delay between | type: Integer |
| | UE | multiplicity: 1 |
| | and EAS (see clause 3.4.2 in GSMA | isOrdered: N/A |
| | OPG.02). | isUnique: True |
| | The unit is Millisecond. | defaultValue: None |
| | | isNullable: False |

The following describes the service area requirements.

| | | |
|---|---|---|
| requiredEASservingLocation | It defines the location where the EAS | type: |
| | service should be available (see clause | ServingLocation |
| | 7.3.3.6 in TS 23.558). | multiplicity: 1 |
| | | isOrdered: N/A |
| | | isUnique: True |
| | | defaultValue: None |
| | | isNullable: False |

6.3.3 ServingLocation <<dataType>>

### 6.3.3.1 Definition

This datatype represents the location which is to be served by the node.

### 6.3.3.2 Attributes

| | Support | | | | |
|---|---|---|---|---|---|
| Attribute name | Qualifier | isReadable | isWritable | isInvariant | isNotifyable |
| geographicalLocation | CM | T | F | F | T |
| topologicalLocation | CM | T | T | F | T |

### 6.3.3.3 Attribute Constraints

| Name | Definition |
|---|---|
| geographicalLocation | Condition: If the serving location is defined as Geographical |
| Support Qualifier | Service Area. |
| topologicalLocation | Condition: If the serving location is defined as Topological |
| Support Qualifier | Service Area. |

NOTE:
Only one of the attributes is needed.

6.3.4 GeoLoc <<dataType>>

### 6.3.4.1 Definition

This datatype represents the geographical location.

### 6.3.4.2 Attributes

| | Support | | | | |
|---|---|---|---|---|---|
| Attribute name | Qualifier | isReadable | isWritable | isInvariant | isNotifyable |
| geographicalCoordinates | CM | T | T | F | T |
| civicLocations | CM | T | T | F | T |

### 6.3.4.3 Attribute Constraints

| Name | Definition |
|---|---|
| geographicalCoordinates | Condition: If the serving location is defined as geographical |
| Support Qualifier | coordinates. |
| civicLocationsSupport | Condition: If the serving location is defined as civic locations. |
| Qualifier | |

NOTE: Only one of the attributes is needed.
6.3.w TopologicalServiceArea <<dataType>>

### 6.3.w.1 Definition

This datatype represents the topological service area.

### 6.3.w.2 Attributes

| | Support | | | | |
|---|---|---|---|---|---|
| Attribute name | Qualifier | isReadable | isWritable | isInvariant | isNotifyable |
| gNBIDList | CM | T | T | F | T |
| trackingAreaIdList | CM | T | T | F | T |
| servingPLMN | CM | T | T | F | T |

### 6.3.w.3 Attribute Constraints

| Name | Definition |
|---|---|
| gNBIDList Support | Condition: If the serving location is defined as cell IDs. |
| Qualifier | |
| trackingAreaIdList Support | Condition: If the serving location is defined as tracking area |
| Qualifier | IDs. |
| servingPLMN Support | Condition: If the serving location is defined as PLMN ID. |
| Qualifier | |

NOTE: Only one of the attributes is needed.

### 6.3.w.4 Notifications

TBD

6.3.x GeographicalCoordinates <<dataType>>

### 6.3.x.1 Definition

This datatype represents the geographical coordinates.

### 6.3.x.2 Attributes

| | Support | | | | |
|---|---|---|---|---|---|
| Attribute name | Qualifier | isReadable | isWritable | isInvariant | isNotifyable |
| lattitude | M | T | T | F | T |
| longitude | M | T | T | F | T |

ECSP consumes the provisioning MnS with createMOI operation for EESFunction IOC to request ECSP provisioning MnS producer to start the EES VNF instantiation, where the EESFunction IOC, defined below, contains the deployment requirements, including eESServiceArea, softwareImageInfo.

### 6.3.v EESFunction

Editor's Note: The definition of IOCs is not complete. It is expected additional attributes, as needed.

### 6.3.v.1 Definition

This IOC represents the EES functionality for supporting Edge Computing.

### 6.3.v.2 Attributes

The EESFunction IOC includes attributes inherited from ManagedFunction IOC (defined in TS 28.622) and the following attributes:

| | Support | | | | |
|---|---|---|---|---|---|
| | Qualifier | isReadable | isWritable | isInvariant | isNotifyable |
| Attribute name | | | | | |
| eesAddress | M | T | T | F | T |
| eESServiceArea | M | T | T | F | T |
| softwareImageInfo | M | T | T | F | T |
| Attribute related to role | | | | | |
| pcfFunctionRef | M | T | T | F | T |
| nefFunctionRef | M | T | T | F | T |

| | | |
|---|---|---|
| eESServiceArea | This parameter defines the EES service area | type: |
| | (see clause 7.3.3.5 in TS 23.558). | ServingLocation |
| | | multiplicity: 1 |
| | | isOrdered: N/A |
| | | isUnique: True |
| | | defaultValue: None |
| | | isNullable: False |

ECSP consumes the provisioning MnS with createMOI operation for ECSFunction IOC to request ECSP provisioning MnS producer to start the ECS VNF instantiation, where the ECSFunction IOC, defined below, contains the deployment requirements, including eDNConnectionInfo, softwareImageInfo.

### 6.3.5 ECSFunction

### 6.3.5.1 Definition

This IOC represents the ECS functionality for supporting Edge Computing. For more information about the ECS, see 3GPP TS 23.558.

### 6.3.5.2 Attributes

The ECSFunction IOC includes attributes inherited from ManagedFunction IOC (defined in TS 28.622) and the following attributes:

| | Support | | | | |
|---|---|---|---|---|---|
| | Qualifier | isReadable | isWritable | isInvariant | isNotifyable |
| Attribute name | | | | | |
| ecsAddress | M | T | T | F | T |
| providerIdentifier | O | T | T | F | T |
| eDNConnectionInfo | M | T | T | F | T |
| softwareImageInfo | M | T | T | F | T |
| Attribute related to role | | | | | |
| nefFunctionRef | M | T | T | F | T |

### 6.3.5.3 Attribute Constraints

None

### 6.3.5.4 Notifications

TBD

### Systems and Implementations

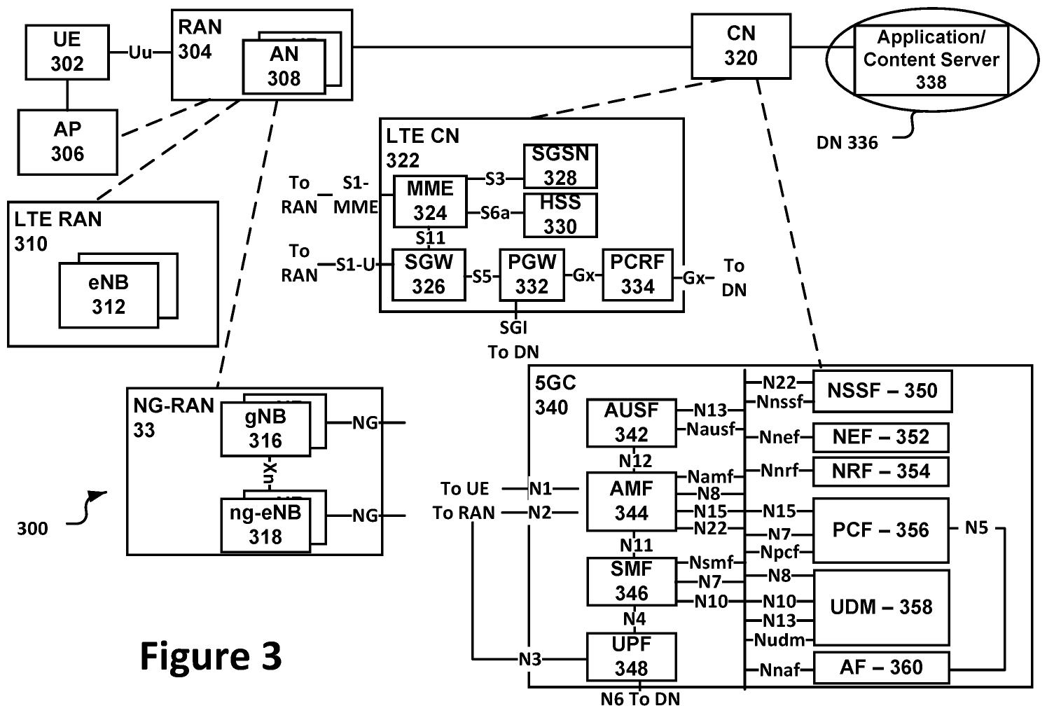

FIGS. 3-5 illustrate various systems, devices, and components that may implement aspects of disclosed embodiments.

FIG. 3 illustrates a network 300 in accordance with various embodiments. The network 300 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 300 may include a UE 302, which may include any mobile or non-mobile computing device designed to communicate with a RAN 304 via an over-the-air connection. The UE 302 may be communicatively coupled with the RAN 304 by a Uu interface. The UE 302 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 300 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 302 may additionally communicate with an AP 306 via an over-the-air connection. The AP 306 may manage a WLAN connection, which may serve to offload some/all network traffic from the RAN 304. The connection between the UE 302 and the AP 306 may be consistent with any IEEE 802.11 protocol, wherein the AP 306 could be a wireless fidelity (Wi-Fi®) router. In some embodiments, the UE 302, RAN 304, and AP 306 may utilize cellular-WLAN aggregation (for example, LWA/LWIP). Cellular-WLAN aggregation may involve the UE 302 being configured by the RAN 304 to utilize both cellular radio resources and WLAN resources.

The RAN 304 may include one or more access nodes, for example, AN 308. AN 308 may terminate air-interface protocols for the UE 302 by providing access stratum protocols including RRC, PDCP, RLC, MAC, and L1 protocols. In this manner, the AN 308 may enable data/voice connectivity between CN 320 and the UE 302. In some embodiments, the AN 308 may be implemented in a discrete device or as one or more software entities running on server computers as part of, for example, a virtual network, which may be referred to as a CRAN or virtual baseband unit pool. The AN 308 be referred to as a BS, gNB, RAN node, eNB, ng-eNB, NodeB, RSU, TRxP, TRP, etc. The AN 308 may be a macrocell base station or a low power base station for providing femtocells, picocells or other like cells having smaller coverage areas, smaller user capacity, or higher bandwidth compared to macrocells.

In embodiments in which the RAN 304 includes a plurality of ANs, they may be coupled with one another via an X2 interface (if the RAN 304 is an LTE RAN) or an Xn interface (if the RAN 304 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 304 may each manage one or more cells, cell groups, component carriers, etc. to provide the UE 302 with an air interface for network access. The UE 302 may be simultaneously connected with a plurality of cells provided by the same or different ANs of the RAN 304. For example, the UE 302 and RAN 304 may use carrier aggregation to allow the UE 302 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 304 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 302 or AN 308 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 304 may be an LTE RAN 310 with eNBs, for example, eNB 312. The LTE RAN 310 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 304 may be an NG-RAN 314 with gNBs, for example, gNB 316, or ng-eNBs, for example, ng-eNB 318. The gNB 316 may connect with 5G-enabled UEs using a 5G NR interface. The gNB 316 may connect with a 5G core through an NG interface, which may include an N2 interface or an N3 interface. The ng-eNB 318 may also connect with the 5G core through an NG interface, but may connect with a UE via an LTE air interface. The gNB 316 and the ng-eNB 318 may connect with each other over an Xn interface.

In some embodiments, the NG interface may be split into two parts, an NG user plane (NG-U) interface, which carries traffic data between the nodes of the NG-RAN 314 and a UPF 348 (e.g., N3 interface), and an NG control plane (NG-C) interface, which is a signaling interface between the nodes of the NG-RAN314 and an AMF 344 (e.g., N2 interface).

The NG-RAN 314 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 302 can be configured with multiple BWPs where each BWP configuration has a different SCS. When a BWP change is indicated to the UE 302, the SCS of the transmission is changed as well. Another use case example of BWP is related to power saving. In particular, multiple BWPs can be configured for the UE 302 with different amount of frequency resources (for example, PRBs) to support data transmission under different traffic loading scenarios. A BWP containing a smaller number of PRBs can be used for data transmission with small traffic load while allowing power saving at the UE 302 and in some cases at the gNB 316. A BWP containing a larger number of PRBs can be used for scenarios with higher traffic load.

The RAN 304 is communicatively coupled to CN 320 that includes network elements to provide various functions to support data and telecommunications services to customers/subscribers (for example, users of UE 302). The components of the CN 320 may be implemented in one physical node or separate physical nodes. In some embodiments, NFV may be utilized to virtualize any or all of the functions provided by the network elements of the CN 320 onto physical compute/storage resources in servers, switches, etc. A logical instantiation of the CN 320 may be referred to as a network slice, and a logical instantiation of a portion of the CN 320 may be referred to as a network sub-slice.

In some embodiments, the CN 320 may be an LTE CN 322, which may also be referred to as an EPC. The LTE CN 322 may include MME 324, SGW 326, SGSN 328, HSS 330, PGW 332, and PCRF 334 coupled with one another over interfaces (or “reference points”) as shown. Functions of the elements of the LTE CN 322 may be briefly introduced as follows.

The MME 324 may implement mobility management functions to track a current location of the UE 302 to facilitate paging, bearer activation/deactivation, handovers, gateway selection, authentication, etc.

The SGW 326 may terminate an Si interface toward the RAN and route data packets between the RAN and the LTE CN 322. The SGW 326 may be a local mobility anchor point for inter-RAN node handovers and also may provide an anchor for inter-3GPP mobility. Other responsibilities may include lawful intercept, charging, and some policy enforcement.

The SGSN 328 may track a location of the UE 302 and perform security functions and access control. In addition, the SGSN 328 may perform inter-EPC node signaling for mobility between different RAT networks; PDN and S-GW selection as specified by MME 324; MME selection for handovers; etc. The S3 reference point between the MME 324 and the SGSN 328 may enable user and bearer information exchange for inter-3GPP access network mobility in idle/active states.

The HSS 330 may include a database for network users, including subscription-related information to support the network entities' handling of communication sessions. The HSS 330 can provide support for routing/roaming, authentication, authorization, naming/addressing resolution, location dependencies, etc. An S6a reference point between the HSS 330 and the MME 324 may enable transfer of subscription and authentication data for authenticating/authorizing user access to the LTE CN 320.

The PGW 332 may terminate an SGi interface toward a data network (DN) 336 that may include an application/content server 338. The PGW 332 may route data packets between the LTE CN 322 and the data network 336. The PGW 332 may be coupled with the SGW 326 by an S5 reference point to facilitate user plane tunneling and tunnel management. The PGW 332 may further include a node for policy enforcement and charging data collection (for example, PCEF). Additionally, the SGi reference point between the PGW 332 and the data network 336 may be an operator external public, a private PDN, or an intra-operator packet data network, for example, for provision of IMS services. The PGW 332 may be coupled with a PCRF 334 via a Gx reference point.

The PCRF 334 is the policy and charging control element of the LTE CN 322. The PCRF 334 may be communicatively coupled to the app/content server 338 to determine appropriate QoS and charging parameters for service flows. The PCRF 332 may provision associated rules into a PCEF (via Gx reference point) with appropriate TFT and QCI.

In some embodiments, the CN 320 may be a 5GC 340. The 5GC 340 may include an AUSF 342, AMF 344, SMF 346, UPF 348, NSSF 350, NEF 352, NRF 354, PCF 356, UDM 358, and AF 360 coupled with one another over interfaces (or “reference points”) as shown. Functions of the elements of the 5GC 340 may be briefly introduced as follows.

The AUSF 342 may store data for authentication of UE 302 and handle authentication-related functionality. The AUSF 342 may facilitate a common authentication framework for various access types. In addition to communicating with other elements of the 5GC 340 over reference points as shown, the AUSF 342 may exhibit an Nausf service-based interface.

The AMF 344 may allow other functions of the 5GC 340 to communicate with the UE 302 and the RAN 304 and to subscribe to notifications about mobility events with respect to the UE 302. The AMF 344 may be responsible for registration management (for example, for registering UE 302), connection management, reachability management, mobility management, lawful interception of AMF-related events, and access authentication and authorization. The AMF 344 may provide transport for SM messages between the UE 302 and the SMF 346, and act as a transparent proxy for routing SM messages. AMF 344 may also provide transport for SMS messages between UE 302 and an SMSF. AMF 344 may interact with the AUSF 342 and the UE 302 to perform various security anchor and context management functions. Furthermore, AMF 344 may be a termination point of a RAN CP interface, which may include or be an N2 reference point between the RAN 304 and the AMF 344; and the AMF 344 may be a termination point of NAS (N1) signaling, and perform NAS ciphering and integrity protection. AMF 344 may also support NAS signaling with the UE 302 over an N3 IWF interface.

The SMF 346 may be responsible for SM (for example, session establishment, tunnel management between UPF 348 and AN 308); UE IP address allocation and management (including optional authorization); selection and control of UP function; configuring traffic steering at UPF 348 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 344 over N2 to AN 308; and determining SSC mode of a session. SM may refer to management of a PDU session, and a PDU session or “session” may refer to a PDU connectivity service that provides or enables the exchange of PDUs between the UE 302 and the data network 336.

The UPF 348 may act as an anchor point for intra-RAT and inter-RAT mobility, an external PDU session point of interconnect to data network 336, and a branching point to support multi-homed PDU session. The UPF 348 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 348 may include an uplink classifier to support routing traffic flows to a data network.

The NSSF 350 may select a set of network slice instances serving the UE 302. The NSSF 350 may also determine allowed NSSAI and the mapping to the subscribed S-NSSAIs, if needed. The NSSF 350 may also determine the AMF set to be used to serve the UE 302, or a list of candidate AMFs based on a suitable configuration and possibly by querying the NRF 354. The selection of a set of network slice instances for the UE 302 may be triggered by the AMF 344 with which the UE 302 is registered by interacting with the NSSF 350, which may lead to a change of AMF. The NSSF 350 may interact with the AMF 344 via an N22 reference point; and may communicate with another NSSF in a visited network via an N31 reference point (not shown). Additionally, the NSSF 350 may exhibit an Nnssf service-based interface.

The NEF 352 may securely expose services and capabilities provided by 3GPP network functions for third party, internal exposure/re-exposure, AFs (e.g., AF 360), edge computing or fog computing systems, etc. In such embodiments, the NEF 352 may authenticate, authorize, or throttle the AFs. NEF 352 may also translate information exchanged with the AF 360 and information exchanged with internal network functions. For example, the NEF 352 may translate between an AF-Service-Identifier and an internal 5GC information. NEF 352 may also receive information from other NFs based on exposed capabilities of other NFs. This information may be stored at the NEF 352 as structured data, or at a data storage NF using standardized interfaces. The stored information can then be re-exposed by the NEF 352 to other NFs and AFs, or used for other purposes such as analytics. Additionally, the NEF 352 may exhibit an Nnef service-based interface.

The NRF 354 may support service discovery functions, receive NF discovery requests from NF instances, and provide the information of the discovered NF instances to the NF instances. NRF 354 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 354 may exhibit the Nnrf service-based interface.

The PCF 356 may provide policy rules to control plane functions to enforce them, and may also support unified policy framework to govern network behavior. The PCF 356 may also implement a front end to access subscription information relevant for policy decisions in a UDR of the UDM 358. In addition to communicating with functions over reference points as shown, the PCF 356 exhibit an Npcf service-based interface.

The UDM 358 may handle subscription-related information to support the network entities' handling of communication sessions, and may store subscription data of UE 302. For example, subscription data may be communicated via an N8 reference point between the UDM 358 and the AMF 344. The UDM 358 may include two parts, an application front end and a UDR. The UDR may store subscription data and policy data for the UDM 358 and the PCF 356, and/or structured data for exposure and application data (including PFDs for application detection, application request information for multiple UEs 302) for the NEF 352. The Nudr service-based interface may be exhibited by the UDR 221 to allow the UDM 358, PCF 356, and NEF 352 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 358 may exhibit the Nudm service-based interface.

The AF 360 may provide application influence on traffic routing, provide access to NEF, and interact with the policy framework for policy control.

In some embodiments, the 5GC 340 may enable edge computing by selecting operator/3^{rd} party services to be geographically close to a point that the UE 302 is attached to the network. This may reduce latency and load on the network. To provide edge-computing implementations, the 5GC 340 may select a UPF 348 close to the UE 302 and execute traffic steering from the UPF 348 to data network 336 via the N6 interface. This may be based on the UE subscription data, UE location, and information provided by the AF 360. In this way, the AF 360 may influence UPF (re)selection and traffic routing. Based on operator deployment, when AF 360 is considered to be a trusted entity, the network operator may permit AF 360 to interact directly with relevant NFs. Additionally, the AF 360 may exhibit an Naf service-based interface.

The data network 336 may represent various network operator services, Internet access, or third party services that may be provided by one or more servers including, for example, application/content server 338.

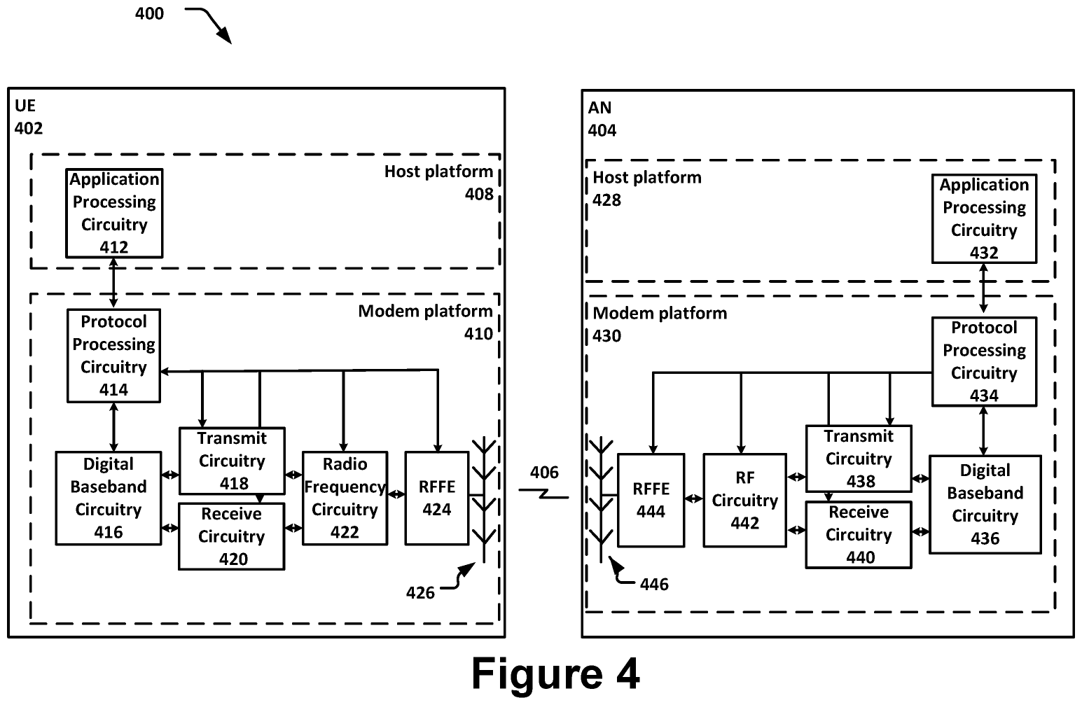

FIG. 4 schematically illustrates a wireless network 400 in accordance with various embodiments. The wireless network 400 may include a UE 402 in wireless communication with an AN 404. The UE 402 and AN 404 may be similar to, and substantially interchangeable with, like-named components described elsewhere herein.

The UE 402 may be communicatively coupled with the AN 404 via connection 406. The connection 406 is illustrated as an air interface to enable communicative coupling, and can be consistent with cellular communications protocols such as an LTE protocol or a 5G NR protocol operating at mmWave or sub-6 GHz frequencies.

The UE 402 may include a host platform 408 coupled with a modem platform 410. The host platform 408 may include application processing circuitry 412, which may be coupled with protocol processing circuitry 414 of the modem platform 410. The application processing circuitry 412 may run various applications for the UE 402 that source/sink application data. The application processing circuitry 412 may further implement one or more layer operations to transmit/receive application data to/from a data network. These layer operations may include transport (for example UDP) and Internet (for example, IP) operations

The protocol processing circuitry 414 may implement one or more of layer operations to facilitate transmission or reception of data over the connection 406. The layer operations implemented by the protocol processing circuitry 414 may include, for example, MAC, RLC, PDCP, RRC and NAS operations.

The modem platform 410 may further include digital baseband circuitry 416 that may implement one or more layer operations that are “below” layer operations performed by the protocol processing circuitry 414 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 410 may further include transmit circuitry 418, receive circuitry 420, RF circuitry 422, and RF front end (RFFE) 424, which may include or connect to one or more antenna panels 426. Briefly, the transmit circuitry 418 may include a digital-to-analog converter, mixer, intermediate frequency (IF) components, etc.; the receive circuitry 420 may include an analog-to-digital converter, mixer, IF components, etc.; the RF circuitry 422 may include a low-noise amplifier, a power amplifier, power tracking components, etc.; RFFE 424 may include filters (for example, surface/bulk acoustic wave filters), switches, antenna tuners, beamforming components (for example, phase-array antenna components), etc. The selection and arrangement of the components of the transmit circuitry 418, receive circuitry 420, RF circuitry 422, RFFE 424, and antenna panels 426 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 414 may include one or more instances of control circuitry (not shown) to provide control functions for the transmit/receive components.

A UE reception may be established by and via the antenna panels 426, RFFE 424, RF circuitry 422, receive circuitry 420, digital baseband circuitry 416, and protocol processing circuitry 414. In some embodiments, the antenna panels 426 may receive a transmission from the AN 404 by receive-beamforming signals received by a plurality of antennas/antenna elements of the one or more antenna panels 426.

A UE transmission may be established by and via the protocol processing circuitry 414, digital baseband circuitry 416, transmit circuitry 418, RF circuitry 422, RFFE 424, and antenna panels 426. In some embodiments, the transmit components of the UE 404 may apply a spatial filter to the data to be transmitted to form a transmit beam emitted by the antenna elements of the antenna panels 426.

Similar to the UE 402, the AN 404 may include a host platform 428 coupled with a modem platform 430. The host platform 428 may include application processing circuitry 432 coupled with protocol processing circuitry 434 of the modem platform 430. The modem platform may further include digital baseband circuitry 436, transmit circuitry 438, receive circuitry 440, RF circuitry 442, RFFE circuitry 444, and antenna panels 446. The components of the AN 404 may be similar to and substantially interchangeable with like-named components of the UE 402. In addition to performing data transmission/reception as described above, the components of the AN 408 may perform various logical functions that include, for example, RNC functions such as radio bearer management, uplink and downlink dynamic radio resource management, and data packet scheduling.

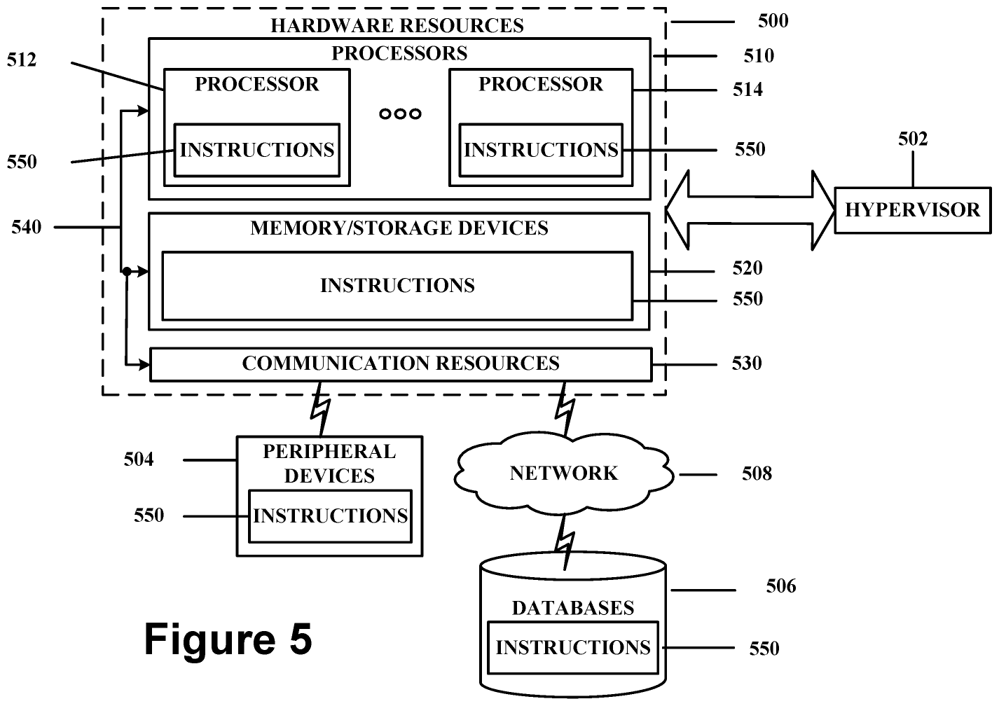

FIG. 5 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 5 shows a diagrammatic representation of hardware resources 500 including one or more processors (or processor cores) 510, one or more memory/storage devices 520, and one or more communication resources 530, each of which may be communicatively coupled via a bus 540 or other interface circuitry. For embodiments where node virtualization (e.g., NFV) is utilized, a hypervisor 502 may be executed to provide an execution environment for one or more network slices/sub-slices to utilize the hardware resources 500.

The processors 510 may include, for example, a processor 512 and a processor 514. The processors 510 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 520 may include main memory, disk storage, or any suitable combination thereof. The memory/storage devices 520 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 530 may include interconnection or network interface controllers, components, or other suitable devices to communicate with one or more peripheral devices 504 or one or more databases 506 or other network elements via a network 508. For example, the communication resources 530 may include wired communication components (e.g., for coupling via USB, Ethernet, etc.), cellular communication components, NFC components, Bluetooth® (or Bluetooth® Low Energy) components, Wi-Fi® components, and other communication components.

Instructions 550 may comprise software, a program, an application, an applet, an app, or other executable code for causing at least any of the processors 510 to perform any one or more of the methodologies discussed herein. The instructions 550 may reside, completely or partially, within at least one of the processors 510 (e.g., within the processor's cache memory), the memory/storage devices 520, or any suitable combination thereof. Furthermore, any portion of the instructions 550 may be transferred to the hardware resources 500 from any combination of the peripheral devices 504 or the databases 506. Accordingly, the memory of processors 510, the memory/storage devices 520, the peripheral devices 504, and the databases 506 are examples of computer-readable and machine-readable media.

### Example Procedures

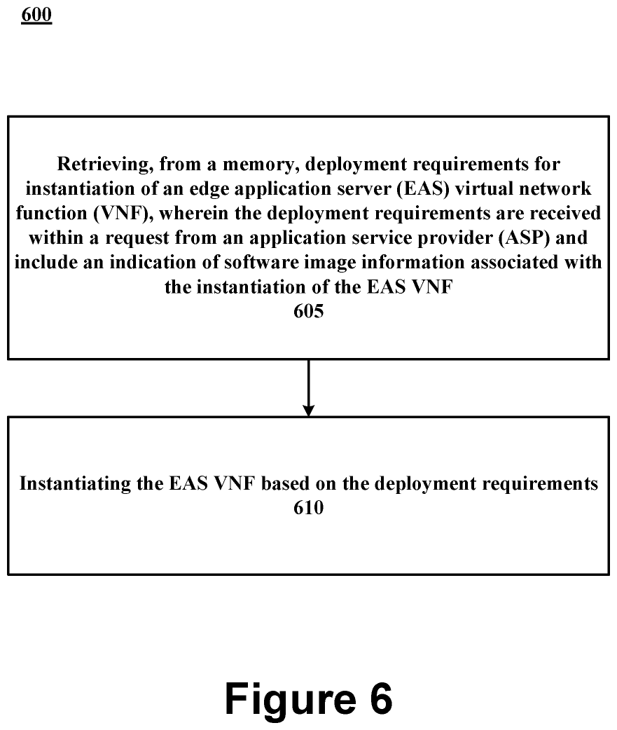

In some embodiments, the electronic device(s), network(s), system(s), chip(s) or component(s), or portions or implementations thereof, of FIGS. 3-5, or some other figure herein, may be configured to perform one or more processes, techniques, or methods as described herein, or portions thereof. One such process is depicted in FIG. 6. Process 600 may be performed by an ECSP management system or portion thereof in some embodiments. In this example, process 600 includes, at 605, retrieving, from a memory, deployment requirements for instantiation of an edge application server (EAS) virtual network function (VNF), wherein the deployment requirements are received within a request from an application service provider (ASP) and include an indication of software image information associated with the instantiation of the EAS VNF. The process further includes, at 610, instantiating the EAS VNF based on the deployment requirements.

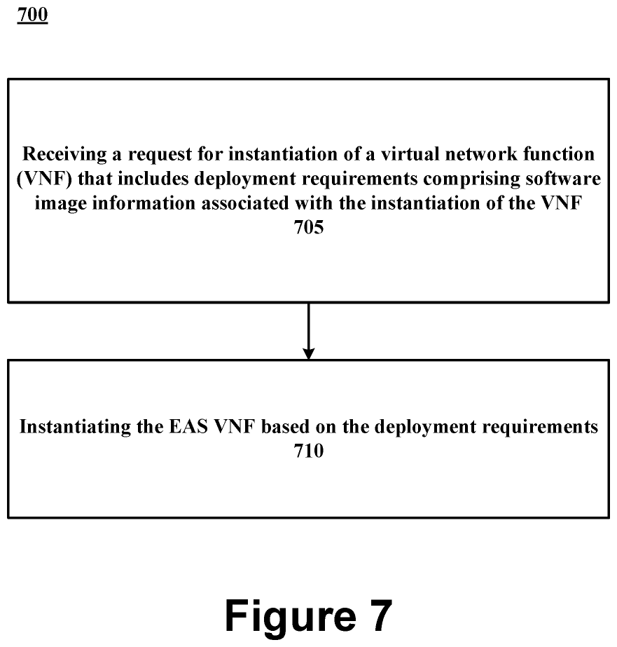

Another such process is depicted in FIG. 7. In this example, process 700 includes, at 705, receiving a request for instantiation of a virtual network function (VNF) that includes deployment requirements comprising software image information associated with the instantiation of the VNF. The process further includes, at 710, instantiating the VNF based on the deployment requirements.

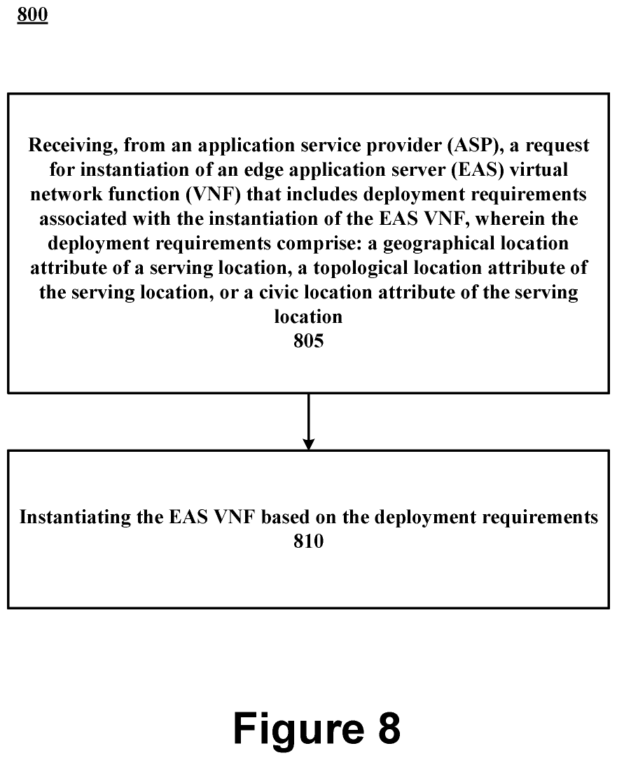

Another such process is depicted in FIG. 8. In this example, process 800 includes, at 805, receiving, from an application service provider (ASP), a request for instantiation of an edge application server (EAS) virtual network function (VNF) that includes deployment requirements associated with the instantiation of the EAS VNF, wherein the deployment requirements comprise: a geographical location attribute of a serving location, a topological location attribute of the serving location, or a civic location attribute of the serving location. The process further includes, at 810, instantiating the EAS VNF based on the deployment requirements.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

Example 1 may include an apparatus comprising: memory; and processing circuitry configured to operate as the provisioning MnS (Management Service) producer at the ECSP management system to deploy the EAS, the processing circuitry is to:
receive the createMOI request from the ASP as the consumer of provisioning MnS with the deployment requirements captured in EASRequirements IOC to request the deployment of EAS; and
instantiate the EAS VNF in the location based on the deployment requirements; and
send a notification to ASP to indicate the result of EAS deployment, based on the result of EAS VNF instantiation.

Example 2 may include the method according to example 1 or some other example herein, wherein the EASRequirements IOC contains:
requiredEASservingLocation attribute that is defined in the ServingLocation dataType; and
softwareImageInfo attribute that is defined in the SoftwareImageInfo dataType; and
qoSRequirements attribute that is defined in the QoSRequirements dataType.

Example 3 may include the method according to examples 2, 9, 11, or some other example herein wherein the ServingLocation is a dataType that contains:
geographicalLocation that is defined in GeoLoc data type to indicate the VNF to be instantiated in the location represented in the geographical format; or
topologicalLocation that is defined in TopologicalServiceArea data type to indicate the VNF to be instantiated in the location represented in the topological format.

Example 4 may include the method according to examples 2, 9, 11, or some other example herein, wherein SoftwareImageInfo dataType is defined as the following:

| | Support | | | | |
|---|---|---|---|---|---|
| | Qualifier | isReadable | isWritable | isInvariant | isNotifyable |
| Attribute name | | | | | |
| minimumDisk | M | T | T | F | T |
| minimumRAM | M | T | T | F | T |
| Attribute | | | | | |
| related to role | | | | | |
| swImageRef | M | T | T | F | T |

| | | |
|---|---|---|
| swImageRef | It indicates the reference to the actual | type: String |
| | software image that is represented by URL | multiplicity: 1 |
| | (see clause 7.1.6.5 in in ETSI NFV IFA-011 | isOrdered: N/A |
| | [7]). | is Unique: True |
| | | defaultValue: |
| | | None |
| | | isNullable: False |
| minimumDisk | It indicates the minimum disk size | type: Integer |
| | requirement for the EAS software (see clause | multiplicity: 1 |
| | 7.1.6.5 in in ETSI NFV IFA-011 [7]). | isOrdered: N/A |
| | The unit is Megabyte. | is Unique: True |
| | | defaultValue: |
| | | None |
| | | isNullable: False |
| minimumRAM | It indicates the minimum RAM size | type: Integer |
| | requirement for the EAS software (see clause | multiplicity: 1 |
| | 7.1.6.5 in in ETSI NFV IFA-011 [7]). | isOrdered: N/A |
| | The unit is Megabyte. | is Unique: True |
| | | defaultValue: |
| | | None |
| | | isNullable: False |

Example 5 may include the method according to examples 2 and 9, or some other example herein, wherein QoSRequirements dataType defined as the following:

| | Support | | | | |
|---|---|---|---|---|---|
| Attribute name | Qualifier | isReadable | isWritable | isInvariant | isNotifyable |
| ueToEasBW | M | T | T | F | T |
| ueToEasLatency | M | T | T | F | T |

| | | |
|---|---|---|
| ueToEasBW | It indicates the bidirectional data rate | type: Integer |
| | between UE and EAS (see clause 3.4.2 in | multiplicity: 1 |
| | GSMA OPG.02 [z]). | isOrdered: N/A |
| | The unit is Megabyte. | isUnique: True |
| | | defaultValue: None |
| | | isNullable: False |
| ueToEasLatency | It indicates the round-trip delay between | type: Integer |
| | UE | multiplicity: 1 |
| | and EAS (see clause 3.4.2 in GSMA | isOrdered: N/A |
| | OPG.02 [z]), | isUnique: True |
| | The unit is Millisecond. | defaultValue: None |
| | | isNullable: False |

Example 6 may include the method according to example 3 or some other example herein, wherein GeoLoc data type is defined as the following:

GeoLoc

| | Support | | | | |
|---|---|---|---|---|---|
| Attribute name | Qualifier | isReadable | isWritable | isInvariant | isNotifyable |
| geographicalCoordinates | CM | T | T | F | T |
| civicLocations | CM | T | T | F | T |

GeographicalCoordinates

| Attribute | Support | | | | |
|---|---|---|---|---|---|
| name | Qualifier | isReadable | isWritable | isInvariant | isNotifyable |
| lattitude | M | T | T | F | T |
| longitude | M | T | T | F | T |

| | | |
|---|---|---|
| lattitude | This defines the single latitude coordinate. | type: Float |
| | | multiplicity: 1 |
| | | isOrdered: N/A |
| | | isUnique: True |
| | | defaultValue: None |
| | | isNullable: False |
| longitude | This defines the single longitudecoordinate. | type: Float |
| | | multiplicity: 1 |
| | | isOrdered: N/A |
| | | isUnique: True |
| | | defaultValue: None |
| | | isNullable: False |
| civicLocation | This defines the civic locations, such as: a | type: String |
| | well-known buildings, parks, arenas, civic | multiplicity: 1 |
| | addresses, or ZIP code etc (see clause | isOrdered: N/A |
| | 7.3.3.3 in TS 23.558 [2]). | isUnique: True |
| | | defaultValue: None |
| | | isNullable: False |

Example 7 may include the method according to example 3 or some other example herein, wherein TopologicalServiceArea data type is defined as the following:

TopologicalServiceArea

| | Support | | | | |
|---|---|---|---|---|---|
| Attribute name | Qualifier | isReadable | isWritable | isInvariant | isNotifyable |
| gNBIDList | CM | T | T | F | T |
| trackingAreaIdList | CM | T | T | F | T |
| servingPLMN | CM | T | T | F | T |

| | | |
|---|---|---|
| gNBIDList | It represents the list of gNB within a | type: Integer |
| | PLMN, where the gNB ID is part of the NR | multiplicity: * |
| | Cell Identifier (NCI) of the gNB cells. | isOrdered: N/A |
| | See “gNB Identifier (gNB ID)” of subclause | isUnique: Yes |
| | 8.2 of TS 38.300 [y]. | defaultValue: None |
| | AllowedValues: 0 . . . 4294967295 | isNullable: True |
| trackingAreaIdList | It represents the list of tracking areas within | type: TAI |
| | a PLMN. | multiplicity: 1 . . .* |
| | | isOrdered: N/A |
| | | isUnique: N/A |
| | | defaultValue: None |
| | | isNullable: False |
| servingPLMN | It specifies the PLMN to be served. | type: PLMNId |
| | | multiplicity: 1 |
| | | isOrdered: F |
| | | isUnique: N/A |
| | | defaultValue: None |
| | | isNullable: True |

Example 8 may include an apparatus comprising: memory; and processing circuitry configured to operate as the provisioning MnS (Management Service) producer at the ECSP management system to deploy the EES, the processing circuitry is to:
receive the createMOI request from the ASP as the consumer of provisioning MnS with the deployment requirements captured in EESFunction IOC to request the deployment of EES; and
instantiate the EES VNF in the location based on the deployment requirements; and send a notification to ASP to indicate the result of EES deployment, based on the result of EES VNF instantiation.

Example 9 may include the method according to example 8 or some other example herein, wherein the EESFunction IOC contains:
eESServiceArea attribute that is defined in the ServingLocation dataType; and
softwareImageInfo attribute that is defined in the SoftwareImageInfo dataType.

Example 10 may include an apparatus comprising: memory; and processing circuitry configured to operate as the provisioning MnS (Management Service) producer at the ECSP management system to deploy the ECS, the processing circuitry is to:
receive the createMOI request from the ASP as the consumer of provisioning MnS with the deployment requirements captured in ECSFunction IOC to request the deployment of EES; and
instantiate the ECS VNF in the location based on the deployment requirements; and
send a notification to ASP to indicate the result of ECS deployment, based on the result of ECS VNF instantiation.

Example 11 may include the method according to example 10 or some other example herein, wherein the ECSFunction IOC contains:
eDNServiceArea attribute that is defined in the ServingLocation dataType; and
softwareImageInfo attribute that is defined in the SoftwareImageInfo dataType.

Example 12 includes a method to be performed by logic of an element of a cellular network, wherein the logic is implemented by one or more processors of one or more electronic devices, the method comprising:
identifying, by the logic, a createMOI request received from a second logic of the cellular network, wherein the createMOI request includes an indication of deployment requirements;
instantiating, by the logic based on the createMOI request, an edge application server (EAS) virtual network function (VNF) in a location that is based on the deployment requirements; and
transmitting, by the logic, an indication of results of the EAS deployment, wherein the results are based on a result of instantiation of the EAS VNF.

Example 13 includes the method of example 12, or some other example herein, wherein the logic is a provisioning management service (MnS) producer.

Example 14 includes the method of example 12, or some other example herein, wherein the second logic is an application service provider (ASP).

Example 15 includes the method of example 12, or some other example herein, wherein the logic is at an ECSP edge computing service provider.

Example 16 includes the method of example 12, or some other example herein, wherein the cellular network is a fifth generation (5G) cellular network.

Example 17 includes the method of example 12, or some other example herein, wherein the indication is an EASRequirements information object class (IOC).

Example X1 includes an apparatus comprising:
memory to store deployment requirements for instantiation of an edge application server (EAS) virtual network function (VNF); and
processing circuitry, coupled with the memory, to:
   retrieve the deployment requirements from the memory, wherein the deployment requirements are received within a request from an application service provider (ASP) and include an indication of software image information associated with the instantiation of the EAS VNF; and
   instantiate the EAS VNF based on the deployment requirements.

Example X2 includes the apparatus of example X1 or some other example herein, wherein the software image information includes: a minimum disk attribute, a minimum random access memory (RAM) attribute, a role attribute, or a software image reference attribute.

Example X3 includes the apparatus of example X2 or some other example herein, wherein the minimum RAM attribute is an integer value to indicate a minimum number of megabytes required for EAS software.

Example X4 includes the apparatus of example X1 or some other example herein, wherein the deployment requirements include a geographical location attribute of a serving location, or a topological location attribute of the serving location.

Example X5 includes the apparatus of example X4 or some other example herein, wherein the topological location attribute includes a next-generation NodeB (gNB) identifier list associated with one or more cell identifiers for the serving location.

Example X6 includes the apparatus of example X4 or some other example herein, wherein the topological location attribute includes a tracking area identifier list associated with one or more tracking area identifiers for the serving location.

Example X7 includes the apparatus of example X4 or some other example herein, wherein the topological location attribute includes a serving public land mobile network (PLMN) identifier associated with the serving location.

Example X8 includes the apparatus of example X4 or some other example herein, wherein:
the geographical location attribute includes a latitude value and a longitude value; or
the geographical location attribute includes a civic location attribute of the serving location.

Example X9 includes the apparatus of any of examples X1-X8 or some other example herein, wherein the apparatus comprises an edge computing service provider (ECSP) management system or portion thereof.

Example X10 includes one or more computer-readable media storing instructions that, when executed by one or more processors, configure an edge computing service provider (ECSP) management system to:
receive a request for instantiation of a virtual network function (VNF) that includes deployment requirements comprising software image information associated with the instantiation of the VNF; and
instantiate the EAS VNF based on the deployment requirements.

Example X11 includes the one or more computer-readable media of example X10 or some other example herein, wherein the request for instantiation of the VNF is:
a request for instantiation of an edge application server (EAS) VNF
a request for instantiation of an edge enabler server (EES) VNF that includes one or more of: an edge enabling server (EES) address, an EES service area, and software image information associated with the instantiation of the EES VNF, wherein upon the instantiation of the EES VNF a policy control function (PCF) reference and a network exposure function (NEF) reference are used to indicate a PCF and NEF to which the EES VNF is connected; or
a request for instantiation of an edge configuration server (ECS) VNF that includes one or more of: an edge configuration server (ECS) address, provider identifier, EDN connection information, and software image information associated with the instantiation of the ECS VNF.

Example X12 includes the one or more computer-readable media of example X10 or some other example herein, wherein the software image information includes: a minimum disk attribute, a minimum random access memory (RAM) attribute, a role attribute, or a software image reference attribute.

Example X13 includes the one or more computer-readable media of example X12 or some other example herein, wherein the minimum RAM attribute is an integer value to indicate a minimum number of megabytes required for EAS software.

Example X14 includes the one or more computer-readable media of example X10 or some other example herein, wherein the deployment requirements include a geographical location attribute of a serving location, or a topological location attribute of the serving location.

Example X15 includes the one or more computer-readable media of example X14 or some other example herein, wherein the topological location attribute includes a next-generation NodeB (gNB) identifier list associated with one or more cell identifiers for the serving location.

Example X16 includes the one or more computer-readable media of example X14 or some other example herein, wherein the topological location attribute includes a tracking area identifier list associated with one or more tracking area identifiers for the serving location.

Example X17 includes the one or more computer-readable media of example X14 or some other example herein, wherein the topological location attribute includes a serving public land mobile network (PLMN) identifier associated with the serving location.

Example X18 includes the one or more computer-readable media of example X14 or some other example herein, wherein:
the geographical location attribute includes a latitude value and a longitude value; or
the geographical location attribute includes a civic location attribute of the serving location.

Example X19 includes one or more computer-readable media storing instructions that, when executed by one or more processors, configure an edge computing service provider (ECSP) management system to:
receive, from an application service provider (ASP), a request for instantiation of an edge application server (EAS) virtual network function (VNF) that includes deployment requirements associated with the instantiation of the EAS VNF, wherein the deployment requirements comprise: a geographical location attribute of a serving location, or a topological location attribute of the serving location; and
instantiate the EAS VNF based on the deployment requirements.

Example X20 includes the one or more computer-readable media of example X19 or some other example herein, wherein deployment requirements further comprise software image information that includes: a minimum disk attribute, a minimum random access memory (RAM) attribute, a role attribute, or a software image reference attribute.

Example X21 includes the one or more computer-readable media of example X20 or some other example herein, wherein the minimum RAM attribute is an integer value to indicate a minimum number of megabytes required for EAS software.

Example X22 includes the one or more computer-readable media of example X19 or some other example herein, wherein the topological location attribute includes:
a next-generation NodeB (gNB) identifier list associated with one or more cell identifiers for the serving location;
a tracking area identifier list associated with one or more tracking area identifiers for the serving location; or
a serving public land mobile network (PLMN) identifier associated with the serving location.

Example X23 includes the one or more computer-readable media of example X19 or some other example herein, wherein:
the geographical location attribute includes a latitude value and a longitude value; or
the geographical location attribute includes a civic location attribute of the serving location.

Example Z01 may include an apparatus comprising means to perform one or more elements of a method described in or related to any of examples 1-X23, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1-X23, or any other method or process described herein.

Example Z03 may include an apparatus comprising logic, modules, or circuitry to perform one or more elements of a method described in or related to any of examples 1-X23, or any other method or process described herein.

Example Z04 may include a method, technique, or process as described in or related to any of examples 1-X23, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1-X23, or portions thereof.

Example Z06 may include a signal as described in or related to any of examples 1-X23, or portions or parts thereof.

Example Z07 may include a datagram, packet, frame, segment, protocol data unit (PDU), or message as described in or related to any of examples 1-X23, or portions or parts thereof, or otherwise described in the present disclosure.

Example Z08 may include a signal encoded with data as described in or related to any of examples 1-X24, or portions or parts thereof, or otherwise described in the present disclosure.

Example Z09 may include a signal encoded with a datagram, packet, frame, segment, protocol data unit (PDU), or message as described in or related to any of examples 1-X23, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1-X23, or portions thereof.

Example Z11 may include a computer program comprising instructions, wherein execution of the program by a processing element is to cause the processing element to carry out the method, techniques, or process as described in or related to any of examples 1-X23, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019 June). For the purposes of the present document, the following abbreviations may apply to the examples and embodiments discussed herein.

| | | |
|---|---|---|
| 3GPP Third Generation | Port, Access Point | Support System |
| Partnership | API Application | BS Base Station |
| Project | Programming Interface | BSR Buffer Status |
| 4G Fourth | APN Access Point | Report |
| Generation | Name | BW Bandwidth |
| 5G Fifth Generation | ARP Allocation and | BWP Bandwidth Part |
| 5GC 5G Core network | Retention Priority | C-RNTI Cell |
| AC | ARQ Automatic | Radio Network |
| Application | Repeat Request | Temporary |
| Client | AS Access Stratum | Identity |
| ACR Application | ASP | CA Carrier |
| Context Relocation | Application Service | Aggregation, |
| ACK | Provider | Certification |
| Acknowledgement | | Authority |
| | ASN.1 Abstract Syntax | CAPEX CAPital |
| ACID | Notation One | EXpenditure |
| Application | AUSF Authentication | CBRA Contention |
| Client Identification | Server Function | Based Random |
| AF Application | AWGN Additive | Access |
| Function | White Gaussian | CC Component |
| AM Acknowledged | Noise | Carrier, Country |
| Mode | BAP Backhaul | Code, Cryptographic |
| AMBRAggregate | Adaptation Protocol | Checksum |
| Maximum Bit Rate | BCH Broadcast | CCA Clear Channel |
| AMF Access and | Channel | Assessment |
| Mobility | BER Bit Error Ratio | CCE Control Channel |
| Management | BFD Beam | Element |
| Function | Failure Detection | CCCH Common |
| AN Access Network | BLER Block Error Rate | Control Channel |
| ANR Automatic | BPSK Binary Phase | CE Coverage |
| Neighbour Relation | Shift Keying | Enhancement |
| AOA Angle of | BRAS Broadband | CDM Content Delivery |
| Arrival | Remote Access | Network |
| AP Application | Server | CDMA Code- |
| Protocol, Antenna | BSS Business | Division Multiple |
| Access | COTS Commercial Off- | CS Circuit Switched |
| CDR Charging Data | The-Shelf | CSCF call |
| Request | CP Control Plane, | session control function |
| CDR Charging Data | Cyclic Prefix, | CSAR Cloud Service |
| Response | Connection | Archive |
| CFRA Contention Free | Point | CSI Channel-State |
| Random Access | CPD Connection | Information |
| CG Cell Group | Point Descriptor | CSI-IM CSI |
| CGF Charging | CPE Customer | Interference |
| Gateway Function | Premise | Measurement |
| CHF Charging | Equipment | CSI-RS CSI |
| Function | CPICHCommon Pilot | Reference Signal |
| CI Cell Identity | Channel | CSI-RSRP CSI |
| CID Cell-ID (e.g., | CQI Channel Quality | reference signal |
| positioning method) | Indicator | received power |
| CIM Common | CPU CSI processing | CSI-RSRQ CSI |
| Information Model | unit, Central | reference signal |
| CIR Carrier to | Processing Unit | received quality |
| Interference Ratio | C/R | CSI-SINR CSI |
| CK Cipher Key | Command/Response | signal-to-noise and |
| CM Connection | field bit | interference ratio |
| Management, | CRAN Cloud Radio | CSMA Carrier Sense |
| Conditional | Access Network, | Multiple Access |
| Mandatory | Cloud RAN | CSMA/CA CSMA |
| CMAS Commercial | CRB Common | with collision |
| Mobile Alert Service | Resource Block | avoidance |
| CMD Command | CRC Cyclic | CSS Common Search |
| CMS Cloud | Redundancy Check | Space, Cell- specific |
| Management System | CRI Channel-State | Search Space |
| CO Conditional | Information Resource | CTF Charging |
| Optional | Indicator, CSI-RS | Trigger Function |
| CoMP Coordinated | Resource | CTS Clear-to-Send |
| Multi-Point | Indicator | CW Codeword |
| CORESET Control | C-RNTI Cell | CWS Contention |
| Resource Set | RNTI | Window Size |
| D2D Device-to- | Access Multiplexer | EEC Edge |
| Device | DwPTS | Enabler Client |
| DC Dual | Downlink Pilot | EECID Edge |
| Connectivity, Direct | Time Slot | Enabler Client |
| Current | E-LAN Ethernet | Identification |
| DCI Downlink | Local Area Network | EES Edge |
| Control | E2E End-to-End | Enabler Server |
| Information | EAS Edge | EESID Edge |
| DF Deployment | Application Server | Enabler Server |
| Flavour | ECCA extended clear | Identification |
| DL Downlink | channel | EHE Edge |
| DMTF Distributed | assessment, | Hosting Environment |
| Management Task | extended CCA | EGMF Exposure |
| Force | ECCE Enhanced | Governance |
| DPDK Data Plane | Control Channel | Management |
| Development Kit | Element, | Function |
| DM-RS, DMRS | Enhanced CCE | EGPRS Enhanced |
| Demodulation | ED Energy | GPRS |
| Reference Signal | Detection | EIR Equipment |
| DN Data network | EDGE Enhanced | Identity Register |
| DNN Data Network | Datarates for GSM | eLAA enhanced |
| Name | Evolution (GSM | Licensed Assisted |
| DNAI Data Network | Evolution) | Access, |
| Access Identifier | EAS Edge | enhanced LAA |
| | Application Server | EM Element |
| DRB Data Radio | EASID Edge | Manager |
| Bearer | Application Server | eMBB Enhanced |
| DRS Discovery | Identification | Mobile |
| Reference Signal | ECS Edge | Broadband |
| DRX Discontinuous | Configuration Server | EMS Element |
| Reception | ECSP Edge | Management System |
| DSL Domain Specific | Computing Service | eNB evolved NodeB, |
| Language. Digital | Provider | E-UTRAN Node B |
| Subscriber Line | EDN Edge | EN-DC E- |
| DSLAM DSL | Data Network | UTRA-NR Dual |
| Connectivity | interface | FEC Forward Error |
| EPC Evolved Packet | F1-U F1 User plane | Correction |
| Core | interface | FFS For Further |
| EPDCCH enhanced | FACCH Fast | Study |
| PDCCH, enhanced | Associated Control | FFT Fast Fourier |
| Physical | CHannel | Transformation |
| Downlink Control | FACCH/F Fast | feLAA further enhanced |
| Cannel | Associated Control | Licensed Assisted |
| EPRE Energy per | Channel/Full | Access, further |
| resource element | rate | enhanced LAA |
| EPS Evolved Packet | FACCH/H Fast | FN Frame Number |
| System | Associated Control | FPGA Field- |
| EREG enhanced REG, | Channel/Half | Programmable Gate |
| enhanced resource | rate | Array |
| element groups | FACH Forward Access | FR Frequency |
| ETSI European | Channel | Range |
| Telecommunications | FAUSCH Fast | FQDN Fully Qualified |
| Standards | Uplink Signalling | Domain Name |
| Institute | Channel | G-RNTI GERAN |
| ETWS Earthquake and | FB Functional Block | Radio Network |
| Tsunami Warning | FBI Feedback | Temporary |
| System | Information | Identity |
| eUICC embedded | FCC Federal | GERAN |
| UICC, embedded | Communications | GSM EDGE |
| Universal | Commission | RAN, GSM EDGE |
| Integrated Circuit | FCCH Frequency | Radio Access |
| Card | Correction CHannel | Network |
| E-UTRA Evolved | FDD Frequency | GGSN Gateway GPRS |
| UTRA | Division Duplex | Support Node |
| E-UTRAN Evolved | FDM Frequency | GLONASS |
| UTRAN | Division Multiplex | GLObal'naya |
| EV2X Enhanced V2X | FDMA Frequency | NAvigatsionnaya |
| F1AP F1 Application | Division Multiple | Sputnikovaya |
| Protocol | Access | Sistema (Engl.: |
| F1-C F1 Control plane | FE Front End | Global Navigation |
| Satellite System) | Unique MME Identifier | Secure (https is |
| gNB Next Generation | GUTI Globally Unique | http/1.1 over |
| NodeB | Temporary UE | SSL, i.e. port 443) |
| gNB-CU gNB- | Identity | I-Block |
| centralized unit, Next | HARQ Hybrid ARQ, | Information |
| Generation | Hybrid | Block |
| NodeB | Automatic | ICCID Integrated |
| centralized unit | Repeat Request | Circuit Card |
| gNB-DU gNB- | HANDO Handover | Identification |
| distributed unit, Next | HFN HyperFrame | IAB Integrated |
| Generation | Number | Access and Backhaul |
| NodeB | HHO Hard Handover | ICIC Inter-Cell |
| distributed unit | HLR Home Location | Interference |
| GNSS Global | Register | Coordination |
| Navigation Satellite | HN Home Network | ID Identity, |
| System | HO Handover | identifier |
| GPRS General Packet | HPLMN Home | IDFT Inverse Discrete |
| Radio Service | Public Land Mobile | Fourier |
| GPSI Generic | Network | Transform |
| Public Subscription | HSDPA High | IE Information |
| Identifier | Speed Downlink | element |
| GSM Global System | Packet Access | IBE In-Band |
| for Mobile | HSN Hopping | Emission |
| Communications, | Sequence Number | IEEE Institute of |
| Groupe Spécial | HSPA High Speed | Electrical and |
| Mobile | Packet Access | Electronics |
| GTP GPRS Tunneling | HSS Home | Engineers |
| Protocol | Subscriber Server | IEI Information |
| GTP-UGPRS | HSUPA High | Element Identifier |
| Tunnelling Protocol | Speed Uplink Packet | IEIDL Information |
| for User Plane | Access | Element Identifier |
| GTS Go To Sleep | HTTP Hyper Text | Data Length |
| Signal (related to | Transfer Protocol | IETF Internet |
| WUS) | HTTPS Hyper | Engineering Task |
| GUMMEI Globally | Text Transfer Protocol | Force |
| IF Infrastructure | Version 4 | KPI Key |
| IIOT Industrial | IPv6 Internet Protocol | Performance Indicator |
| Internet of Things | Version 6 | KQI Key Quality |
| IM Interference | IR Infrared | Indicator |
| Measurement, | IS In Sync | KSI Key Set |
| Intermodulation, | IRP Integration | Identifier |
| IP Multimedia | Reference Point | ksps kilo-symbols per |
| IMC IMS Credentials | ISDN Integrated | second |
| IMEI International | Services Digital | KVM Kernel Virtual |
| Mobile | Network | Machine |
| Equipment | ISIM IM Services | L1 Layer 1 |
| Identity | Identity Module | (physical layer) |
| IMGI International | ISO International | L1-RSRP Layer 1 |
| mobile group identity | Organisation for | reference signal |
| IMPI IP Multimedia | Standardisation | received power |
| Private Identity | ISP Internet Service | L2 Layer 2 (data |
| IMPU IP Multimedia | Provider | link layer) |
| PUblic identity | IWF Interworking- | L3 Layer 3 (network |
| IMS IP Multimedia | Function | layer) |
| Subsystem | I-WLAN | LAA Licensed |
| IMSI International | Interworking | Assisted Access |
| Mobile | WLAN | LAN Local Area |
| Subscriber | Constraint length | Network |
| Identity | of the convolutional | LADN Local |
| IoT Internet of | code, USIM | Area Data Network |
| Things | Individual key | LBT Listen Before |
| IP Internet Protocol | kB Kilobyte (1000 | Talk |
| Ipsec IP Security, | bytes) | LCM LifeCycle |
| Internet Protocol | kbps kilo-bits per | Management |
| Security | second | LCR Low Chip Rate |
| IP-CAN IP- | Kc Ciphering key | LCS Location |
| Connectivity Access | Ki Individual | Services |
| Network | subscriber | LCID Logical |
| IP-M IP Multicast | authentication | Channel ID |
| IPv4 Internet Protocol | key | LI Layer Indicator |
| LLC Logical Link | and key | MDT Minimization of |
| Control, Low Layer | agreement (TSG | Drive Tests |
| Compatibility | T WG3 context) | ME Mobile |
| LMF Location | MAC-IMAC used for | Equipment |
| Management Function | data integrity of | MeNB master eNB |
| LOS Line of | signalling messages | MER Message Error |
| Sight | (TSG T WG3 context) | Ratio |
| LPLMN Local | MANO | MGL Measurement |
| PLMN | Management and | Gap Length |
| LPP LTE Positioning | Orchestration | MGRP Measurement |
| Protocol | MBMS | Gap Repetition |
| LSB Least Significant | Multimedia | Period |
| Bit | Broadcast and Multicast | MIB Master |
| LTE Long Term | Service | Information Block, |
| Evolution | MBSFN | Management |
| LWA LTE-WLAN | Multimedia | Information Base |
| aggregation | Broadcast multicast | MIMO Multiple Input |
| LWIP LTE/WLAN | service Single | Multiple Output |
| Radio Level | Frequency | MLC Mobile Location |
| Integration with | Network | Centre |
| IPsec Tunnel | MCC Mobile Country | MM Mobility |
| LTE Long Term | Code | Management |
| Evolution | MCG Master Cell | MME Mobility |
| M2M Machine-to- | Group | Management Entity |
| Machine | MCOT Maximum | MN Master Node |
| MAC Medium Access | Channel | MNO Mobile |
| Control (protocol | Occupancy Time | Network Operator |
| layering context) | MCS Modulation and | MO Measurement |
| MAC Message | coding scheme | Object, Mobile |
| authentication code | MDAF Management | Originated |
| (security/encryption | Data Analytics | MPBCH MTC |
| context) | Function | Physical Broadcast |
| MAC-A MAC | MDAS Management | CHannel |
| used for | Data Analytics | MPDCCH MTC |
| authentication | Service | Physical Downlink |
| Control CHannel | mMTCmassive MTC, | Functions |
| MPDSCH MTC | massive Machine- | Virtualization |
| Physical Downlink | Type Communications | NFVI NFV |
| Shared CHannel | MU-MIMO Multi | Infrastructure |
| MPRACH MTC | User MIMO | NFVO NFV |
| Physical Random | MWUS MTC | Orchestrator |
| Access CHannel | wake-up signal, MTC | NG Next Generation, |
| MPUSCH MTC | WUS | Next Gen |
| Physical Uplink Shared | NACK Negative | NGEN-DC NG-RAN |
| Channel | Acknowledgement | E-UTRA-NR Dual |
| MPLS MultiProtocol | NAI Network Access | Connectivity |
| Label Switching | Identifier | NM Network |
| MS Mobile Station | NAS Non-Access | Manager |
| MSB Most Significant | Stratum, Non- Access | NMS Network |
| Bit | Stratum layer | Management System |
| MSC Mobile | NCT Network | N-PoP Network Point of |
| Switching Centre | Connectivity Topology | Presence |
| MSI Minimum | NC-JT Non- | NMIB, N-MIB |
| System | Coherent Joint | Narrowband MIB |
| Information, | Transmission | NPBCH |
| MCH Scheduling | NEC Network | Narrowband |
| Information | Capability Exposure | Physical |
| MSID Mobile Station | NE-DC NR-E- | Broadcast |
| Identifier | UTRA Dual | CHannel |
| MSIN Mobile Station | Connectivity | NPDCCH |
| Identification | NEF Network | Narrowband |
| Number | Exposure Function | Physical |
| MSISDN Mobile | NF Network | Downlink |
| Subscriber ISDN | Function | Control CHannel |
| Number | NFP Network | NPDSCH |
| MT Mobile | Forwarding Path | Narrowband |
| Terminated, Mobile | NFPD Network | Physical |
| Termination | Forwarding Path | Downlink |
| MTC Machine-Type | Descriptor | Shared CHannel |
| Communications | NFV Network | NPRACH |
| Narrowband | Selection Function | PCC Primary |
| Physical Random | NW Network | Component Carrier, |
| Access CHannel | NWUSNarrowband | Primary CC |
| NPUSCH | wake-up signal, | P-CSCF Proxy |
| Narrowband | Narrowband WUS | CSCF |
| Physical Uplink | NZP Non-Zero Power | PCell Primary Cell |
| Shared CHannel | O&M Operation and | PCI Physical Cell ID, |
| NPSS Narrowband | Maintenance | Physical Cell |
| Primary | ODU2 Optical channel | Identity |
| Synchronization | Data Unit - type 2 | PCEF Policy and |
| Signal | OFDM Orthogonal | Charging |
| NSSS Narrowband | Frequency Division | Enforcement |
| Secondary | Multiplexing | Function |
| Synchronization | OFDMA | PCF Policy Control |
| Signal | Orthogonal | Function |
| NR New Radio, | Frequency Division | PCRF Policy Control |
| Neighbour Relation | Multiple Access | and Charging Rules |
| NRF NF Repository | OOB Out-of-band | Function |
| Function | OOS Out of Sync | PDCP Packet Data |
| NRS Narrowband | OPEX OPerating | Convergence Protocol, |
| Reference Signal | EXpense | Packet Data |
| NS Network Service | OSI Other System | Convergence |
| NSA Non-Standalone | Information | Protocol layer |
| operation mode | OSS Operations | PDCCH Physical |
| NSD Network Service | Support System | Downlink Control |
| Descriptor | OTA over-the-air | Channel |
| NSR Network Service | PAPR Peak-to-Average | PDCP Packet Data |
| Record | Power Ratio | Convergence Protocol |
| NSSAINetwork Slice | PAR Peak to Average | PDN Packet Data |
| Selection | Ratio | Network, Public |
| Assistance | PBCH Physical | Data Network |
| Information | Broadcast Channel | PDSCH Physical |
| S-NNSAI Single- | PC Power Control, | Downlink Shared |
| NSSAI | Personal | Channel |
| NSSF Network Slice | Computer | PDU Protocol Data |
| Unit | PRB Physical | PUCCH Physical |
| PEI Permanent | resource block | Uplink Control |
| Equipment | PRG Physical | Channel |
| Identifiers | resource block | PUSCH Physical |
| PFD Packet Flow | group | Uplink Shared |
| Description | ProSe Proximity | Channel |
| P-GW PDN Gateway | Services, | QAM Quadrature |
| PHICH Physical | Proximity-Based | Amplitude |
| hybrid-ARQ indicator | Service | Modulation |
| channel | PRS Positioning | QCI QoS class of |
| PHY Physical layer | Reference Signal | identifier |
| PLMN Public Land | PRR Packet | QCL Quasi co- |
| Mobile Network | Reception Radio | location |
| PIN Personal | PS Packet Services | QFI QoS Flow ID, |
| Identification Number | PSBCH Physical | QoS Flow Identifier |
| PM Performance | Sidelink Broadcast | QoS Quality of |
| Measurement | Channel | Service |
| PMI Precoding | PSDCH Physical | QPSK Quadrature |
| Matrix Indicator | Sidelink Downlink | (Quaternary) Phase |
| PNF Physical | Channel | Shift Keying |
| Network Function | PSCCH Physical | QZSS Quasi-Zenith |
| PNFD Physical | Sidelink Control | Satellite System |
| Network Function | Channel | RA-RNTI Random |
| Descriptor | PSSCH Physical | Access RNTI |
| PNFR Physical | Sidelink Shared | RAB Radio Access |
| Network Function | Channel | Bearer, Random |
| Record | PSCell Primary SCell | Access Burst |
| POC PTT over | PSS Primary | RACH Random Access |
| Cellular | Synchronization | Channel |
| PP, PTP Point-to- | Signal | RADIUS Remote |
| Point | PSTN Public Switched | Authentication Dial In |
| PPP Point-to-Point | Telephone Network | User Service |
| Protocol | PT-RS Phase-tracking | RAN Radio Access |
| PRACH Physical | reference signal | Network |
| RACH | PTT Push-to-Talk | RAND RANDom |
| number (used for | for RLM | RTP Real Time |
| authentication) | RM Registration | Protocol |
| RAR Random Access | Management | RTS Ready-To-Send |
| Response | RMC Reference | RTT Round Trip |
| RAT Radio Access | Measurement Channel | Time |
| Technology | RMSI Remaining MSI, | Rx Reception, |
| RAU Routing Area | Remaining | Receiving, Receiver |
| Update | Minimum | S1AP S1 Application |
| RB Resource block, | System | Protocol |
| Radio Bearer | Information | S1-MME S1 for the |
| RBG Resource block | RN Relay Node | control plane |
| group | RNC Radio Network | S1-U S1 for the user |
| REG Resource | Controller | plane |
| Element Group | RNL Radio Network | S-CSCF serving |
| Rel Release | Layer | CSCF |
| REQ REQuest | RNTI Radio Network | S-GW Serving Gateway |
| RF Radio Frequency | Temporary Identifier | S-RNTI SRNC |
| RI Rank Indicator | ROHC RObust Header | Radio Network |
| RIV Resource | Compression | Temporary |
| indicator value | RRC Radio Resource | Identity |
| RL Radio Link | Control, Radio | S-TMSI SAE |
| RLC Radio Link | Resource Control | Temporary Mobile |
| Control, Radio | layer | Station Identifier |
| Link Control | RRM Radio Resource | SA Standalone |
| layer | Management | operation mode |
| RLC AM RLC | RS Reference Signal | SAE System |
| Acknowledged Mode | RSRP Reference Signal | Architecture Evolution |
| RLC UM RLC | Received Power | SAP Service Access |
| Unacknowledged Mode | RSRQ Reference Signal | Point |
| RLF Radio Link | Received Quality | SAPD Service Access |
| Failure | RSSI Received Signal | Point Descriptor |
| RLM Radio Link | Strength Indicator | SAPI Service Access |
| Monitoring | RSU Road Side Unit | Point Identifier |
| RLM-RS | RSTD Reference Signal | SCC Secondary |
| Reference Signal | Time difference | Component Carrier, |
| Secondary CC | Unit | SMF Session |
| SCell Secondary Cell | SEAF Security Anchor | Management Function |
| SCEF Service | Function | SMS Short Message |
| Capability Exposure | SeNB secondary eNB | Service |
| Function | SEPP Security Edge | SMSF SMS Function |
| SC-FDMA Single | Protection Proxy | SMTC SSB-based |
| Carrier Frequency | SFI Slot format | Measurement Timing |
| Division | indication | Configuration |
| Multiple Access | SFTD Space-Frequency | SN Secondary Node, |
| SCG Secondary Cell | Time Diversity, SFN | Sequence Number |
| Group | and frame timing | SoC System on Chip |
| SCM Security Context | difference | SON Self-Organizing |
| Management | SFN System Frame | Network |
| SCS Subcarrier | Number | SpCell Special Cell |
| Spacing | SgNB Secondary gNB | SP-CSI-RNTISemi- |
| SCTP Stream Control | SGSN Serving GPRS | Persistent CSI RNTI |
| Transmission | Support Node | SPS Semi-Persistent |
| Protocol | S-GW Serving Gateway | Scheduling |
| SDAP Service Data | SI System | SQN Sequence |
| Adaptation Protocol, | Information | number |
| Service Data | SI-RNTI System | SR Scheduling |
| Adaptation | Information RNTI | Request |
| Protocol layer | SIB System | SRB Signalling Radio |
| SDL Supplementary | Information Block | Bearer |
| Downlink | SIM Subscriber | SRS Sounding |
| SDNF Structured Data | Identity Module | Reference Signal |
| Storage Network | SIP Session Initiated | SS Synchronization |
| Function | Protocol | Signal |
| SDP Session | SiP System in | SSB Synchronization |
| Description Protocol | Package | Signal Block |
| SDSF Structured Data | SL Sidelink | SSID Service Set |
| Storage Function | SLA Service Level | Identifier |
| SDT Small Data | Agreement | SS/PBCH Block |
| Transmission | SM Session | SSBRI SS/PBCH Block |
| SDU Service Data | Management | Resource Indicator, |
| Synchronization | Advance, Tracking | TNL Transport |
| Signal Block | Area | Network Layer |
| Resource Indicator | TAC Tracking Area | TPC Transmit Power |
| SSC Session and | Code | Control |
| Service | TAG Timing Advance | TPMI Transmitted |
| Continuity | Group | Precoding Matrix |
| SS-RSRP | TAI Tracking | Indicator |
| Synchronization | Area Identity | TR Technical Report |
| Signal based | TAU Tracking Area | TRP, TRxP |
| Reference Signal | Update | Transmission |
| Received Power | TB Transport Block | Reception Point |
| SS-RSRQ | TBS Transport Block | TRS Tracking |
| Synchronization | Size | Reference Signal |
| Signal based | TBD To Be Defined | TRx Transceiver |
| Reference Signal | TCI Transmission | TS Technical |
| Received Quality | Configuration Indicator | Specifications, |
| SS-SINR | TCP Transmission | Technical |
| Synchronization | Communication | Standard |
| Signal based Signal to | Protocol | TTI Transmission |
| Noise and Interference | TDD Time Division | Time Interval |
| Ratio | Duplex | Tx Transmission, |
| SSS Secondary | TDM Time Division | Transmitting, |
| Synchronization | Multiplexing | Transmitter |
| Signal | TDMATime Division | U-RNTI UTRAN |
| SSSG Search Space Set | Multiple Access | Radio Network |
| Group | TE Terminal | Temporary |
| SSSIF Search Space Set | Equipment | Identity |
| Indicator | TEID Tunnel End | UART Universal |
| SST Slice/Service | Point Identifier | Asynchronous |
| Types | TFT Traffic Flow | Receiver and |
| SU-MIMO Single | Template | Transmitter |
| User MIMO | TMSI Temporary | UCI Uplink Control |
| SUL Supplementary | Mobile | Information |
| Uplink | Subscriber | UE User Equipment |
| TA Timing | Identity | UDM Unified Data |
| Management | search space | VPLMN Visited |
| UDP User Datagram | UTRA UMTS | Public Land Mobile |
| Protocol | Terrestrial Radio | Network |
| UDSF Unstructured | Access | VPN Virtual Private |
| Data Storage Network | UTRAN Universal | Network |
| Function | Terrestrial Radio | VRB Virtual Resource |
| UICC Universal | Access Network | Block |
| Integrated Circuit | UwPTS Uplink | WiMAX |
| Card | Pilot Time Slot | Worldwide |
| UL Uplink | V2I Vehicle-to- | Interoperability |
| UM | Infrastruction | for Microwave |
| Unacknowledged | V2P Vehicle-to- | Access |
| Mode | Pedestrian | WLANWireless Local |
| UML Unified | V2V Vehicle-to- | Area Network |
| Modelling Language | Vehicle | WMAN Wireless |
| UMTS Universal | V2X Vehicle-to- | Metropolitan Area |
| Mobile | everything | Network |
| Telecommunications | VIM Virtualized | WPANWireless |
| System | Infrastructure Manager | Personal Area Network |
| UP User Plane | VL Virtual Link, | X2-C X2-Control |
| UPF User Plane | VLAN Virtual LAN, | plane |
| Function | Virtual Local Area | X2-U X2-User plane |
| URI Uniform | Network | XML eXtensible |
| Resource Identifier | VM Virtual Machine | Markup Language |
| URL Uniform | VNF Virtualized | XRES EXpected user |
| Resource Locator | Network Function | RESponse |
| URLLC Ultra- | VNFFG VNF | XOR eXclusive OR |
| Reliable and Low | Forwarding Graph | ZC Zadoff-Chu |
| Latency | VNFFGD VNF | ZP Zero Power |
| USB Universal Serial | Forwarding Graph | |
| Bus | Descriptor | |
| USIM Universal | VNFMVNF Manager | |
| Subscriber Identity | VoIP Voice-over-IP, | |
| Module | Voice-over- Internet | |
| USS UE-specific | Protocol | |

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes.

Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

1.-23. (canceled)

24. An apparatus comprising:
memory to store deployment requirements for instantiation of an edge application server (EAS) virtual network function (VNF); and
processing circuitry, coupled with the memory, to:
retrieve the deployment requirements from the memory, wherein the deployment requirements are received within a request from an application service provider (ASP) and include an indication of software image information associated with the instantiation of the EAS VNF; and
instantiate the EAS VNF based on the deployment requirements.

25. The apparatus of claim 24, wherein the software image information includes: a minimum disk attribute, a minimum random access memory (RAM) attribute, a role attribute, or a software image reference attribute.

26. The apparatus of claim 25, wherein the minimum RAM attribute is an integer value to indicate a minimum number of megabytes required for EAS software.

27. The apparatus of claim 24, wherein the deployment requirements include a geographical location attribute of a serving location, or a topological location attribute of the serving location.

28. The apparatus of claim 27, wherein the topological location attribute includes a next-generation NodeB (gNB) identifier list associated with one or more cell identifiers for the serving location.

29. The apparatus of claim 27, wherein the topological location attribute includes:
a tracking area identifier list associated with one or more tracking area identifiers for the serving location; or
a serving public land mobile network (PLMN) identifier associated with the serving location.

30. The apparatus of claim 27, wherein:
the geographical location attribute includes a latitude value and a longitude value; or
the geographical location attribute includes a civic location attribute of the serving location.

31. The apparatus of claim 24, wherein the apparatus comprises an edge computing service provider (ECSP) management system or portion thereof.

32. One or more non-transitory computer-readable media storing instructions that, when executed by one or more processors, configure an edge computing service provider (ECSP) management system to:
receive a request for instantiation of a virtual network function (VNF) that includes deployment requirements comprising software image information associated with the instantiation of the VNF; and
instantiate the VNF based on the deployment requirements.

33. The one or more non-transitory computer-readable media of claim 32, wherein the request for instantiation of the VNF is:
a request for instantiation of an edge application server (EAS) VNF;
a request for instantiation of an edge enabler server (EES) VNF that includes one or more of: an edge enabling server (EES) address, an EES service area, and software image information associated with the instantiation of the EES VNF, wherein upon the instantiation of the EES VNF a policy control function (PCF) reference and a network exposure function (NEF) reference are used to indicate a PCF and NEF to which the EES VNF is connected; or
a request for instantiation of an edge configuration server (ECS) VNF that includes one or more of: an edge configuration server (ECS) address, provider identifier, EDN connection information, and software image information associated with the instantiation of the ECS VNF.

34. The one or more non-transitory computer-readable media of claim 33, wherein the software image information includes: a minimum disk attribute, a minimum random access memory (RAM) attribute, a role attribute, or a software image reference attribute.

35. The one or more non-transitory computer-readable media of claim 34, wherein the minimum RAM attribute is an integer value to indicate a minimum number of megabytes required for EAS software.

36. The one or more non-transitory computer-readable media of claim 32, wherein the deployment requirements include a geographical location attribute of a serving location, or a topological location attribute of the serving location.

37. The one or more non-transitory computer-readable media of claim 36, wherein the topological location attribute includes:
a next-generation NodeB (gNB) identifier list associated with one or more cell identifiers for the serving location;
a tracking area identifier list associated with one or more tracking area identifiers for the serving location; or
a serving public land mobile network (PLMN) identifier associated with the serving location.

38. The one or more non-transitory computer-readable media of claim 36, wherein:
the geographical location attribute includes a latitude value and a longitude value; or
the geographical location attribute includes a civic location attribute of the serving location.

39. One or more non-transitory computer-readable media storing instructions that, when executed by one or more processors, configure an edge computing service provider (ECSP) management system to:
receive, from an application service provider (ASP), a request for instantiation of an edge application server (EAS) virtual network function (VNF) that includes deployment requirements associated with the instantiation of the EAS VNF, wherein the deployment requirements comprise: a geographical location attribute of a serving location, or a topological location attribute of the serving location; and
instantiate the EAS VNF based on the deployment requirements.

40. The one or more non-transitory computer-readable media of claim 39, wherein deployment requirements further comprise software image information that includes: a minimum disk attribute, a minimum random access memory (RAM) attribute, a role attribute, or a software image reference attribute.

41. The one or more non-transitory computer-readable media of claim 40, wherein the minimum RAM attribute is an integer value to indicate a minimum number of megabytes required for EAS software.

42. The one or more non-transitory computer-readable media of claim 39, wherein the topological location attribute includes:
a next-generation NodeB (gNB) identifier list associated with one or more cell identifiers for the serving location;
a tracking area identifier list associated with one or more tracking area identifiers for the serving location; or
a serving public land mobile network (PLMN) identifier associated with the serving location.

43. The one or more non-transitory computer-readable media of claim 39, wherein the geographical location attribute includes:
a latitude value and a longitude value; or
a civic location attribute of the serving location.
